(19) United States
(12) Patent Application Publication
(10) Pub. No.: US 2025/0390323 A1
(43) Pub. Date: Dec. 25, 2025

(54) METHOD FOR GENERATING A RECOMMENDATION RELATED TO USER PREFERENCES

(71) Applicant: Schlumberger Technology Corporation, Sugar Land, TX (US)

(72) Inventors: Swapnil Dubey, Pune (IN); Neha Agrawal, Pune (IN); Shashwat Kumar, Pune (IN)

(21) Appl. No.: 19/243,919

(22) Filed: Jun. 20, 2025

(30) Foreign Application Priority Data
Jun. 20, 2024 (IN) 202411047565

(51) Int. Cl. G06F 9/451; G06F 11/34

(52) U.S. Cl. CPC G06F 9/451; G06F 11/3438

(57) ABSTRACT

A method for generating a recommendation related to user preferences. The method includes capturing user interactions related to a plurality of widgets. Each of the widgets are user interface widgets and relate to a corresponding dataset. Capturing the plurality of user interactions may include recording how much time or frequency each user spends viewing each of the widgets, recording how long since each user last interacted with each of the widgets, or recording how many users have interacted with each of the widgets. A list of recommended widgets based on the captured user interactions is created and then displayed to each user. Displaying the list of recommended widgets includes displaying the list of recommended widgets on a landing page of an application, displaying a subsequent widget to each user, or displaying a subsequent application to each user. Once displayed, the widgets provide the users with a suggested midstream facility action.

### CROSS-REFERENCE TO RELATED APPLICATIONS

This patent application claims priority to India Provisional Application No. 202411047565, filed on Jun. 20, 2024, which is incorporated by reference herein in its entirety.

### BACKGROUND

A user journey tracks the behavior of a user when they are interacting with a product, application, or program. A user journey can include a generated map that can give insights into the user's mind to see what they are thinking, feeling, and seeing at every point of interaction. If these interactions are captured at each point of user interaction, analysis may be performed on that data so that recommendations are defined, and the user journey path(s) may be customized so that the recommendations are the most relevant for the given user, even classifying whether it is relevant for the user today, or relevant for the user in general when interacting with the product.

In midstream oil and gas (O&G) applications, generally, there are a number of user interface (UI) widgets that may be made available to the user so that they can monitor or analyze different datasets in a certain way. It is highly probable that in a facility, for example in a system that includes various management components to manage various aspects of a geologic environment, a field engineer may end up looking at or interacting with the same widget a majority of the time as compared to other widgets which may be available. The length or frequency a specific user may interact with a certain widget can vary from user to user, for example users who have different roles in the facility or work within a different facility altogether. Similarly, for example in certain workflows, all available applications are not important at the same time, and instead there may be some set of ‘preferable’ applications that are more relevant at certain times than others.

What is needed is a means for meeting the user's requirements by providing them a maximum of possible options as direct links in the landing page. The means may be a ‘general’ solution and designed for many types of customers. The means may ‘personalize’ the user's experience for them by identifying the most relevant user journey relevant for each corresponding user, thereby greatly increasing their customer satisfaction.

### SUMMARY

A method is provided for generating a recommendation related to user preferences. The method includes receiving a plurality of data sets from at least one source disposed at a site by a management application, implementing the data sets into a plurality of widgets within the management application, and capturing a plurality of user interactions related to the widgets for a plurality of users. The method may further include creating a list of recommended widgets based on the captured user interactions for each user, displaying the list of recommended widgets to each user, and then providing a suggested item to each user in response to the list of recommended widgets.

Also provided is a computing system which includes one or more processors and a memory system having one or more non-transitory computer-readable media storing instructions that, when executed by at least one of the one or more processors, cause the computing system to perform operations. The operations may include receiving a plurality of data sets from at least one source disposed at a site by a management application, implementing the data sets into a plurality of widgets within the management application, and capturing a plurality of user interactions related to the widgets for a plurality of users. The operations may further include creating a list of recommended widgets based on the captured user interactions for each user, displaying the list of recommended widgets to each user, and providing a suggested item to each user in response to the list of recommended widgets. The operations may also include performing a site action in response to the suggested item.

Also provided is a non-transitory computer-readable medium storing instructions that, when executed by one or more processors of a computing system, cause the computing system to perform operations. The operations may include receiving a plurality of data sets from at least one source disposed at a site by a management application, implementing the data sets into a plurality of widgets within the management application, and capturing a plurality of user interactions related to the widgets. The widgets may be user interface widgets related to equipment disposed at the site. The source at the site may include equipment disposed at the site or actions performed at the site. In certain embodiments, capturing the plurality of user interactions includes recording how much time a user spends viewing each of the widgets, recording a frequency each user has viewed each of the widgets, recording how long since each user last interacted with any one of the widgets; or recording how many users have interacted with any one of the widgets. The operations may further include creating a list of recommended widgets based on the captured user interactions. The list of recommended widgets may be unique to each user. The list of recommended widgets may list the plurality of widgets in an order of relevancy as determined for each user. The operations may also include displaying the list of recommended widgets to each user. The list of recommended widgets may be displayed on a screen. The list of recommended widgets may include the captured user interactions. In certain embodiments, displaying the list of recommended widgets includes displaying the list of recommended widgets on a landing page of an application, predicting a further widget for each user based on the corresponding captured user interactions of the user. and displaying the further widget predicted for each user within the list of recommended widgets. In certain embodiments, the operations also include providing a suggested item to each user in response to the list of recommended widgets and performing a site action in response to the suggested item. The site action may include a midstream facility action. The midstream facility action may include generating or transmitting a signal that instructs or causes an action to occur. The action may include a physical action. The physical action may include selecting where to drill a wellbore in the subsurface formation, drilling the wellbore, varying a trajectory of the wellbore, varying a weight or torque on a drill bit that is drilling the wellbore, varying a rate or concentration of a fluid being pumped into the wellbore, maintaining site equipment as per methodologies within a manual provided by the original equipment manufacturer or based on a subject matter expert deployed in the facility who ensures a quality of crude emitted from the midstream facility, or a combination thereof.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart for generating a recommended widget or application related to user preferences, according to an embodiment.

FIG. 3 illustrates several different exemplary interactions which may be captured by the management application, according to an embodiment.

FIG. 4 illustrates a flowchart of a method for providing a suggested item in response to user preferences, according to an embodiment.

FIG. 5 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

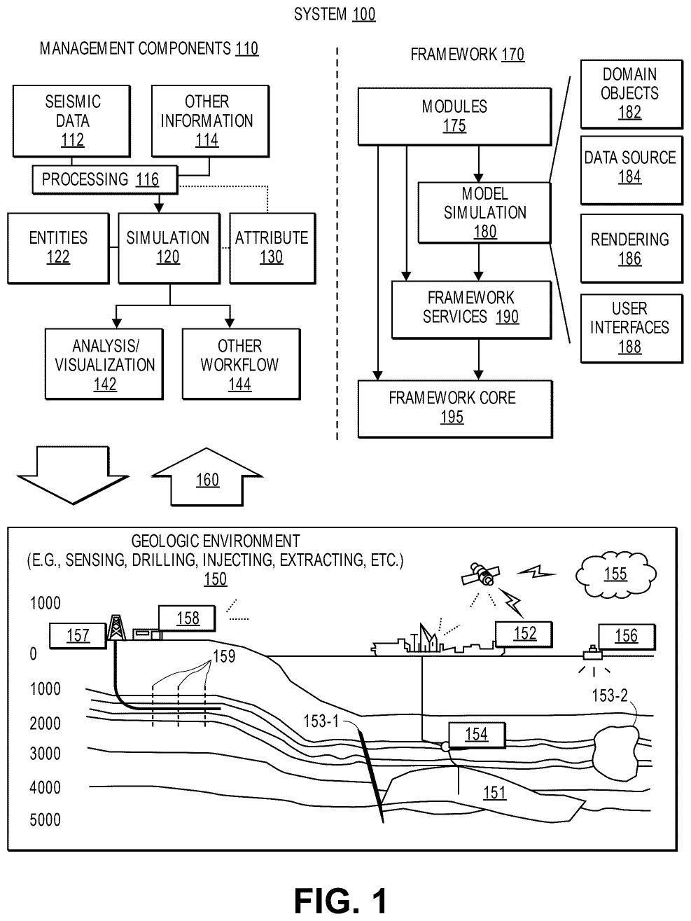

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the. NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Method for Generating a Recommendation Related to User Preferences

A production mid-stream oil and gas (O&G) management application, which may run on the management components 110 of the system 100, can be used to track the information related to a user's interaction with the application, beginning from the loading of a view page having widgets that customers directly interact with. As used herein, “widget” refers to any self-contained application which allows a user to interact with a larger system or environment. Algorithms, for example, HyperLogLog, may be applied to or run on top of the collected dataset of the user's interaction information to identify information that corresponds to each unique user, for example, an identification of the specific widgets or combinations of widgets that a specific user interacted with over a predetermined time frame.

According to certain embodiments, multiple logics or algorithms can be run on a dataset containing the user's interaction information in order to quickly create an ordered list of the most preferred or recommended widgets for any specific user. According to certain embodiments, the multiple logics or algorithms may include factors such as but not limited to a history of usage related to each user which suggests a frequency of usage, how recently any specific widget has been used which suggests the relevancy of the usage in the current context, or how many users are looking for the same widget over a predetermined time frame which suggests an urgency or necessity of any particular widget.

According to certain embodiments, the generated list of widgets may be displayed to the user in the order of preference as determined by the various factors taken into account while analyzing the dataset containing the user's interaction information. In certain embodiments, the UI displayed on the management components 110 could present the most relevant widgets/workflow link on a landing page of the application so that the user can directly attend to the business relevant to him/her and avoid too much information on the landing page. In certain embodiments, an association may be created between two widgets and, based on how an individual jumps from one widget to the other, the user's emotional response to a particular context can be predicted and a next suggestive step may be provided by the UI. In other embodiments, a business or manager of the system 100 can use the generated user journey maps to deepen their understanding of product usage and patterns and come up with plans to make more focused business strategies. According to some embodiments, the method may be further extended by umbrella applications, for example Delfi®, to give similar recommendations for other applications run by the management components 110. For example, in Delfi®, a unique combination for each user and each application may be identified to give further recommendations to that user for other applications.

In certain embodiments, each of the widgets may include images, graphical displays, text, or illustrations which effectually represent a corresponding dataset and may be displayed or supported by a management application that is communicated to a site. In certain embodiments, the management application may be disposed at the site at an edge device, or it may be connected to the site via a network or Cloud infrastructure. According to certain embodiments, each of the corresponding datasets may be obtained from separate objects, sensors, or equipment that are disposed at the site or from actions or procedures which are performed at the site. Each dataset may be transmitted or monitored by the management application and displayed to a user via an appropriate widget. In certain embodiments, the site may be a production midstream facility. In certain embodiments, the management application may include a display for displaying the widgets to the user, or the software management platform may be connected to a remote display via a network or Cloud infrastructure.

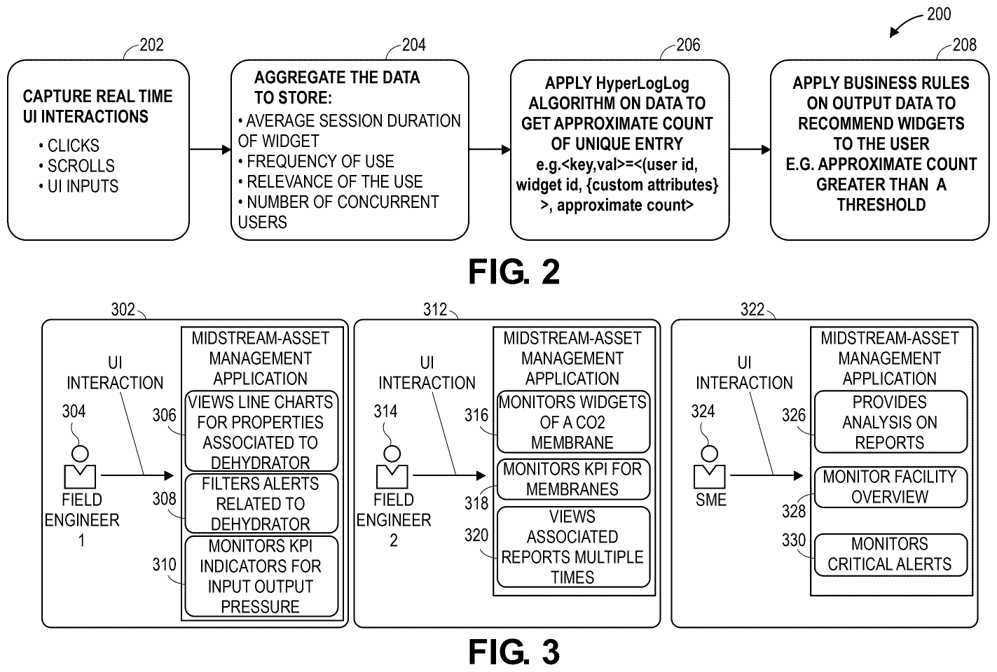

According to certain embodiments, a method 200 for generating a recommended widget or application related to user preferences may be provided as seen in FIG. 2. Initially, real time interactions with a UI of the widget may be captured by the management application, as at 202. Interactions that may be captured include but are not limited to clicks made by the user on the UI, scrolls by the user within the UI, and other UI inputs now known or later devised. FIG. 3 illustrates several different exemplary interactions which may be captured by the management application. In a first example 302, a first field engineer 304 may interact with the UI of the management application by viewing line charts for properties associated with a dehydrator disposed at the site 306, filtering alerts related to the dehydrator 308, and monitoring key performance indicators related to input or output pressure 310. In a second example 312, a second field engineer 314 may interact with the UI of the management application by monitoring widgets related to a CO2 membrane 316, monitoring key performance indicators for the membrane 318, and viewing associated reports multiple times 320. In a third example 322, a subject matter expert 324 may interact with the UI of the management application by providing analysis on reports 326, monitoring facility overview 328, and monitoring critical alerts 330. Regardless of the user or which specific widgets or series of widgets the user interacts with, each interaction may be captured and incorporated by the management application.

Returning to FIG. 2, the captured data may then be aggregated and then stored, as at 204. The captured data may be aggregated according to an average session or duration a user has spent interacting with a widget, the frequency that a user has interacted with a widget over a predetermined amount of time, a predicted relevancy of the widget to the user, and the number of users who have interacted with the same widget. It should be noted that the captured data may be aggregated into other categories or classifications beyond what is explicitly shown in FIG. 2. Next, as at 206, the HyperLogLog algorithm may be applied to the aggregated data, the algorithm configured to obtain an approximate count of unique entries, each entry including a record of a specific user and the specific widgets that the specific user has interacted with. In certain embodiments, if the approximate count of a unique entry exceeds a predetermined threshold, the method 200 may include recommending a further widget via the application of predefined business rules as at 208.

In one particular embodiment, a workflow using the system may progress as follows. A sensor, for example a sensor that may be used to measure the concentration of CO2 may be disposed at the site. A data set related to the measurements recorded by the CO2 sensor may be transmitted to the management application which may then display or incorporate the data received from the CO2 sensor into an appropriate widget or graphical display on a user interface. For example, the widget may be a line graph showing the concentration of CO2 measured by the CO2 sensor over a predetermined amount of time. The user may then interact with the widget by, for example, displaying the line graph on their screen, clicking on the line graph using a mouse or keyboard, or otherwise manipulating the widget. The management application monitors each of the user's interactions and if a certain predetermined interactivity threshold is met as discussed above, the management application may make a further recommendation to the user as to which additional widgets the user may likely use next or which widgets may assist the user in understanding the data displayed by the widget corresponding to the CO2 sensor. For example, if the user is recorded as displaying the widget corresponding to the CO2 sensor on their screen for over 5 minutes, the management application may recommend a further widget corresponding to an oxygen sensor disposed at the site or a widget which contains associated reports related to CO2 concentrations by displaying the recommended widget on the user's screen. The user may then review both widgets and may decide to perform a physical act in response to the information displayed therein, for example by adjusting a concentration of a gas that is in proximity to the CO2 sensor, recalibrating or replacing the CO2 sensor, consulting a related manual provided by the original manufacturer of the CO2 sensor, or the like.

### Exemplary Method

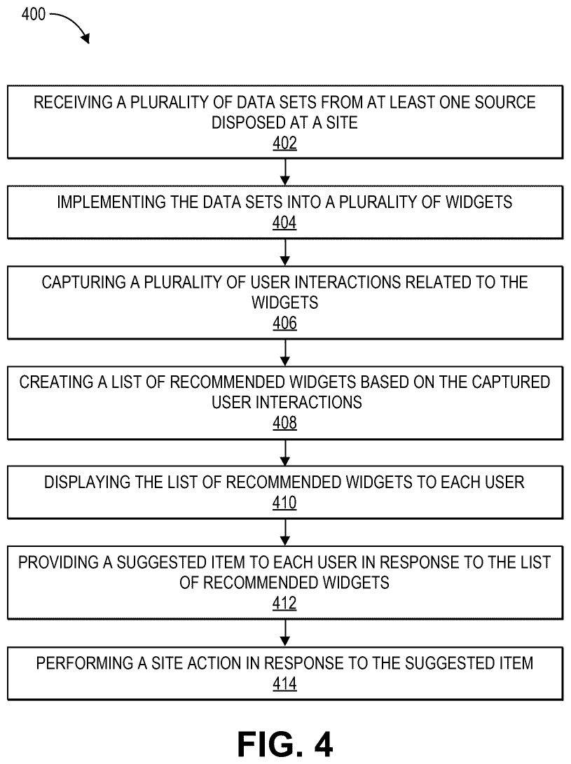

FIG. 4 illustrates a flowchart of a method 400 for generating a recommendation related to user preferences. An illustrative order of the method 400 is provided below; however, one or more portions of the method 400 may be performed in a different order, simultaneously, repeated, or omitted. At least a portion of the method 400 may be performed by a computing system as further described below.

The method 400 may include receiving a plurality of data sets from at least one source disposed at a site by a management application, as at 402. In an example, the data sets may be or include data received or collected from equipment or sensors disposed at the site. In certain embodiments, the method 400 may also include implementing the data sets into a plurality of widgets within the management application, as at 404. In an example, the widgets may be or include text, images, video, or other graphical displays on a user interface which communicates the received data to the user in an easily comprehensible format.

In certain embodiments, the method 400 may include capturing a plurality of user interactions related to the widgets, as at 406. The widgets may be user interface widgets related to equipment disposed at the site. The source at the site may include equipment disposed at the site or actions performed at the site. In certain embodiments, capturing the plurality of user interactions may include recording how much time a user spends viewing each of the widgets, recording the frequency each user has viewed each of the widgets, recording how long since each user last interacted with any one of the widgets, or recording how many users have interacted with any one of the widgets.

In certain embodiments, the method 400 may include creating a list of recommended widgets based on the captured user interactions, as at 408. The list of recommended widgets may be unique to each user. The list of recommended widgets may list the plurality of widgets in an order of relevancy as determined for each user.

In certain embodiments, the method 400 may include displaying the list of recommended widgets to each user, as at 410. The list of recommended widgets may be displayed on a screen. The list of recommended widgets may include the captured user interactions. In certain embodiments, displaying the list of recommended widgets may include displaying the list of recommended widgets on a landing page of an application, predicting a further widget for each user based on the corresponding captured user interactions of the user, and then displaying the further widget predicted for each user within the list of recommended widgets.

In certain embodiments, the method 400 includes providing a suggested item to each user in response to the list of recommended widgets, as at 412. In an example, the suggested item may be or include a further widget or application, or in some embodiments, a manual or a portion of a manual provided by the original equipment manufacturer.

In certain embodiments, the method 400 includes performing a site action in response to the suggested item, as at 414. The site action may include a midstream facility action. The midstream facility action may include generating or transmitting a signal that instructs or causes an action to occur. The action may include a physical action. The physical action may include selecting where to drill a wellbore in the subsurface formation, drilling the wellbore, varying a trajectory of the wellbore, varying a weight or torque on a drill bit that is drilling the wellbore, varying a rate or concentration of a fluid being pumped into the wellbore, maintaining site equipment (e.g., as per methodologies within a manual or a portion of a manual provided by the original equipment manufacturer or based on a subject matter expert) deployed in the facility that ensures a quality of crude emitted from the midstream facility, or a combination thereof.

### Exemplary Computing System

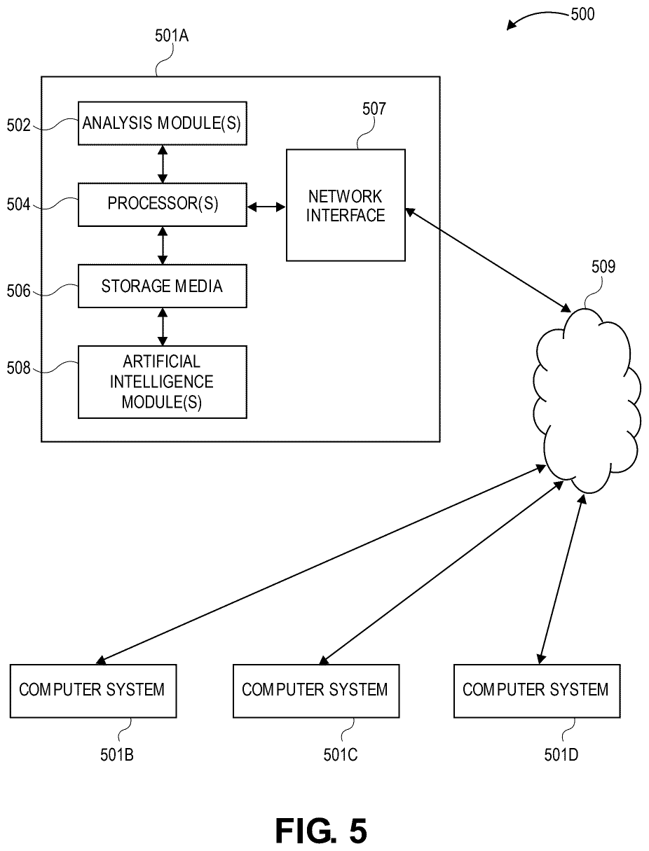

In some embodiments, the methods of the present disclosure may be executed by a computing system. FIG. 5 illustrates an example of such a computing system 500, in accordance with some embodiments. The computing system 500 may include a computer or computer system 501A, which may be an individual computer system 501A or an arrangement of distributed computer systems. The computer system 501A includes one or more analysis modules 502 that are configured to perform various tasks according to some embodiments, such as one or more methods disclosed herein. To perform these various tasks, the analysis module 502 executes independently, or in coordination with, one or more processors 504, which is (or are) connected to one or more storage media 506. The processor(s) 504 is (or are) also connected to a network interface 507 to allow the computer system 501A to communicate over a data network 509 with one or more additional computer systems and/or computing systems, such as 501B, 501C, and/or 501D (note that computer systems 501B, 501C and/or 501D may or may not share the same architecture as computer system 501A, and may be located in different physical locations, e.g., computer systems 501A and 501B may be located in a processing facility, while in communication with one or more computer systems such as 501C and/or 501D that are located in one or more data centers, and/or located in varying countries on different continents).

A processor may include a microprocessor, microcontroller, processor module or subsystem, programmable integrated circuit, programmable gate array, or another control or computing device.

In some embodiments, computing system 500 contains one or more artificial intelligence module(s) 508. In the example of computing system 500, computer system 501A includes the artificial intelligence module 508. In some embodiments, a single method execution module may be used to perform some aspects of one or more embodiments of the methods disclosed herein. In other embodiments, a plurality of method execution modules may be used to perform some aspects of methods herein.

The storage media 506 may be implemented as one or more computer-readable or machine-readable storage media. Note that while in the example embodiment of FIG. 5 storage media 506 is depicted as within computer system 501A, in some embodiments, storage media 506 may be distributed within and/or across multiple internal and/or external enclosures of computing system 501A and/or additional computing systems. Storage media 506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

It should be appreciated that computing system 500 is merely one example of a computing system, and that computing system 500 may have more or fewer components than shown, may combine additional components not depicted in the example embodiment of FIG. 5, and/or computing system 500 may have a different configuration or arrangement of the components depicted in FIG. 5. The various components shown in FIG. 5 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 500, FIG. 5), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for generating a recommendation related to user preferences, the method comprising:
receiving a plurality of data sets from at least one source disposed at a site by a management platform;
implementing the data sets into a plurality of widgets within the management platform;
capturing a plurality of user interactions related to the widgets for a plurality of users;
creating a list of recommended widgets based on the captured user interactions for each user, wherein the recommended widgets are a subset of the plurality of widgets;
displaying the list of recommended widgets to each user; and
providing a suggested item to each user in response to the list of recommended widgets.

2. The method of claim 1, wherein the widgets are user interface widgets related to equipment disposed at the site.

3. The method of claim 1, wherein the source at the site comprises equipment disposed at the site or actions performed at the site.

4. The method of claim 1, wherein capturing the plurality of user interactions comprises:
recording how much time a user spends viewing each of the widgets;
recording a frequency each user has viewed each of the widgets;
recording how long since each user has last interacted with any one of the widgets; or
recording how many users have interacted with any one of the widgets.

5. The method of claim 1, wherein the list of recommended widgets is unique to each user.

6. The method of claim 1, wherein the list of recommended widgets lists the plurality of widgets in an order of relevancy as determined for each user.

7. The method of claim 1, wherein the list of recommended widgets is displayed on a screen.

8. The method of claim 1, further comprising:
creating a list of recommended applications based on the captured user interactions for each user;
displaying the list of recommended applications to each user; and
providing a suggested item to each user in response to the list of recommended applications.

9. The method of claim 1, wherein displaying the list of recommended widgets comprises displaying the list of recommended widgets on a landing page of an application.

10. The method of claim 1, further comprising performing a site action in response to the suggested item.

11. A computing system, comprising:
one or more processors; and
a memory system comprising one or more non-transitory computer-readable media storing instructions that, when executed by at least one of the one or more processors, cause the computing system to perform operations, the operations comprising:
receiving a plurality of data sets from at least one source disposed at a site by a management platform;
implementing the data sets into a plurality of widgets within the management platform;
capturing a plurality of user interactions related to the widgets for a plurality of users;
creating a list of recommended widgets based on the captured user interactions for each user;
displaying the list of recommended widgets to each user;
providing a suggested item to each user in response to the list of recommended widgets; and
performing a site action in response to the suggested item.

12. The computing system of claim 11, wherein the operations further comprise predicting a further widget for each user based on the corresponding captured user interactions of the user.

13. The computing system of claim 12, wherein providing the suggested item to each user comprises displaying the further widget predicted for each user within the list of recommended widgets.

14. The computing system of claim 11, wherein providing the suggested item to each user comprises providing a sequence of widgets or applications for each user based on the corresponding captured user interactions of the user.

15. The computing system of claim 11, wherein the source disposed at the site comprises equipment, sensors, or objects disposed at the site.

16. The computing system of claim 11, wherein providing the suggested item to each user comprises providing at least a portion of a manual provided by an original equipment manufacturer.

17. The computing system of claim 16, wherein providing at least a portion of the manual comprises providing a portion of the manual based on the captured user interactions for each of the users.

18. The computing system of claim 11, wherein displaying the list of recommended widgets to each user comprises transmitting the list to a user located remotely from the site.

19. The computing system of claim 11, wherein the site action comprises a midstream facility action, wherein the midstream facility action comprises generating or transmitting a signal that instructs or causes an action to occur, wherein the action comprises a physical action, and wherein the physical action comprises selecting where to drill a wellbore in the subsurface formation, drilling the wellbore, varying a trajectory of the wellbore, varying a weight or torque on a drill bit that is drilling the wellbore, varying a rate or concentration of a fluid being pumped into the wellbore, maintaining site equipment as per methodologies within a manual provided by the original equipment manufacturer or based on a subject matter expert deployed in the facility who ensures a quality of crude emitted from the midstream facility, or a combination thereof.

20. A non-transitory computer-readable medium storing instructions that, when executed by one or more processors of a computing system, cause the computing system to perform operations, the operations comprising:
receiving a plurality of data sets from at least one source disposed at a site by a management platform;
implementing the data sets into a plurality of widgets within the management platform;
capturing a plurality of user interactions related to the widgets, wherein the widgets are user interface widgets related to equipment disposed at the site, wherein the source at the site comprises equipment disposed at the site or actions performed at the site, wherein capturing the plurality of user interactions comprises:
recording how much time a user spends viewing each of the widgets;
recording a frequency each user has viewed each of the widgets;
recording how long since each user last interacted with any one of the widgets; or
recording how many users have interacted with any one of the widgets;
creating a list of recommended widgets based on the captured user interactions, wherein the list of recommended widgets is unique to each user, wherein the list of recommended widgets lists the plurality of widgets in an order of relevancy as determined for each user;
displaying the list of recommended widgets to each user, wherein the list of recommended widgets is displayed on a screen, wherein the list of recommended widgets comprises the captured user interactions, wherein displaying the list of recommended widgets comprises:
displaying the list of recommended widgets on a landing page of an application;
predicting a further widget for each user based on the corresponding captured user interactions of the user; and
displaying the further widget predicted for each user within the list of recommended widgets,
providing a suggested item to each user in response to the list of recommended widgets; and
performing a site action in response to the suggested item, wherein the site action comprises a midstream facility action, wherein the midstream facility action comprises generating or transmitting a signal that instructs or causes an action to occur, wherein the action comprises a physical action, and wherein the physical action comprises selecting where to drill a wellbore in the subsurface formation, drilling the wellbore, varying a trajectory of the wellbore, varying a weight or torque on a drill bit that is drilling the wellbore, varying a rate or concentration of a fluid being pumped into the wellbore, maintaining site equipment as per methodologies within a manual provided by the original equipment manufacturer or based on a subject matter expert deployed in the facility who ensures a quality of crude emitted from the midstream facility, or a combination thereof.
